(19) United States
(12) Patent Application Publication
(10) Pub. No.: US 2007/0132253 A1
(43) Pub. Date: Jun. 14, 2007

(54) Equipment and accessory retrieval system

(76) Inventor: Kurt Santayana, Luzerne, PA (US)

Correspondence Address: RATNERPRESTIA, P O BOX 980, VALLEY FORGE, PA, 19482-0980, US

(21) Appl. No.: 11/637,649

(22) Filed: Dec. 12, 2006

Related U.S. Application Data
(60) Provisional application No. 60/749,528, filed on Dec. 12, 2005.

(51) Int. Cl. B25J 1/02

(52) U.S. Cl. 294/2

(57) ABSTRACT

A kit for use by a person in an elevated position above ground level for retrieving an object positioned below the person is provided. The kit comprises a cable, and at least two different retrieval components disposed within the kit, wherein each retrieval component may be selectively coupled to the cable and lowered to retrieve the object positioned below the person.

This application claims priority of U.S. Provisional Patent Application Ser. No. 60/749,528 filed Dec. 12, 2005.

### FIELD OF THE INVENTION

The present invention relates to outdoor tools, and more specifically to a retrieval system for retrieving equipment and accessories.

### BACKGROUND OF THE INVENTION

In a typical tree stand hunting scenario, the hunter travels to the hunting location carrying a tree stand, a rifle or bow, and a backpack containing food, beverages and other accessories. Known to those skilled in the art of hunting, many conventional tree stands are also referred to as “self-climbing” tree stands. A self-climbing tree stand generally comprises a portable platform and a separate portable seating device.

Tree stands have grown in popularity over the years in large part because of the advantages offered over conventional hunting techniques. By positioning oneself in a tree at a lofty elevation, the hunter is above the normal line of sight of most prey, and his or her scent is distant from the forest floor. Moreover, at a high elevation, the hunter's scent is dispersed more quickly into the wind and away from the prey.

Prior to ascending the tree and installing the tree stand, the hunter must complete several laborious and time consuming tasks in preparation for the climb. The hunter first assembles the tree stand on the ground. The hunter then prepares a rope to pull up his or her backpack and weapon to the tree stand, because a hunter typically does not climb the tree holding the weapon (for safety reasons) or the heavy backpack. In the interest of safety, the hunter prepares and attaches a safety harness to himself or herself and the tree. The hunter then climbs the tree to an elevation of ten to twenty feet. Upon climbing the tree, the hunter grasps the seat portion with one hand, while the platform is suspended from the hunter's legs (via a foot stirrup, or other device). Once the hunter reaches the desired elevation, the hunter attaches the portable platform, seating device, and tree stand safety devices to the tree trunk. The hunter may then sit on the platform portion of the tree stand, and retrieve the backpack and weapon using the pull rope. The hunter then organizes the equipment and prepares the weapon (i.e., load the rifle) and relevant equipment (bow release/knock arrow) in preparation for the hunt.

Upon climbing the tree, settling into the tree stand, and organizing the equipment, it is uncommon for an object, such as the weapon, ammunition, clothing (such as a hat or glove), or any other article, to have fallen onto the ground. In such an event, the hunter must begrudgingly lower all of the equipment to the ground and climb down the tree to retrieve the fallen item, which consumes time and energy. The process of climbing down the tree also creates noise, movement and scent laydown, which may undesirably scare away prey. The present invention provides a solution to this common problem experienced by tree stand hunters.

### SUMMARY OF THE INVENTION

The present invention relates to a retrieval system for retrieving hunting, fishing or camping equipment, accessories and sundries. The retrieval system is particularly useful for a hunter perched in a tree who is attempting to retrieve an object that has fallen to the ground. A preferred embodiment of the invention includes a cable and a combination of retrieval components that are packaged into a case. The retrieval components include a barbed hook, a noose, an adhesive component, and a magnet. The retrieval components may be packaged and stored within a case or container having multiple compartments, wherein each retrieval component is stored in a respective compartment. According to another aspect of the invention, the case comprises a plurality of stackable compartments, wherein each retrieval component is stored in a respective compartments, and the compartments are threadedly connected, snap-fit, or buckled together.

According to one aspect of the invention, a kit for use by a person in an elevated position above ground level for retrieving an object positioned below the person is provided. The kit comprises a retrieval cable, and at least two different retrieval components disposed within the kit, wherein each retrieval component may be selectively coupled to the cord and lowered to retrieve the object positioned below the person.

### BRIEF DESCRIPTION OF THE DRAWINGS

The invention is best understood from the following detailed description when read in connection with the accompanying drawing. It is emphasized that, according to common practice, the various features of the drawing may not be to scale. Included in the drawing are the following figures:

FIG. 1 is a perspective view of an equipment and accessory retrieval kit comprising a carrying case having multiple internal compartments, wherein a retrieval cable, a hook, a weighted adhesive, a noose, and a magnet are organized in the respective compartments of the case;

FIG. 2 is a detailed perspective view of the retrieval cable, hook, weighted adhesive, noose, and the magnet of FIG. 1;

FIG. 3 is a perspective view of another exemplary retrieval kit organized in a carrying case comprising stackable compartments; and

FIG. 4 is a partial cut-away view of a compartment of the carrying case of FIG. 3.

### DETAILED DESCRIPTION OF THE INVENTION

The invention will next be illustrated with reference to the Figures. Such figures are intended to be illustrative rather than limiting and are included herewith to facilitate explanation of the present invention. The figures are not necessarily to scale, and are not intended to serve as engineering drawings.

The invention disclosed herein comprises an equipment and accessory retrieval kit including a master retrieval cable, multiple retrieval components that are each mountable to the retrieval cable, and a case for storing those items. The invention can be used by outdoor enthusiasts such as hunters, fishermen, hikers, boaters, campers, etc., to retrieve dropped equipment or accessories. The invention has particular application to a hunter perched in a tree.

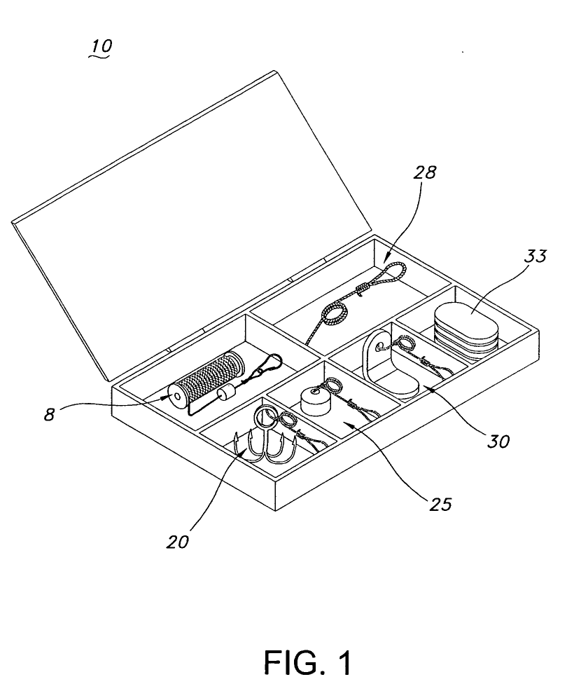

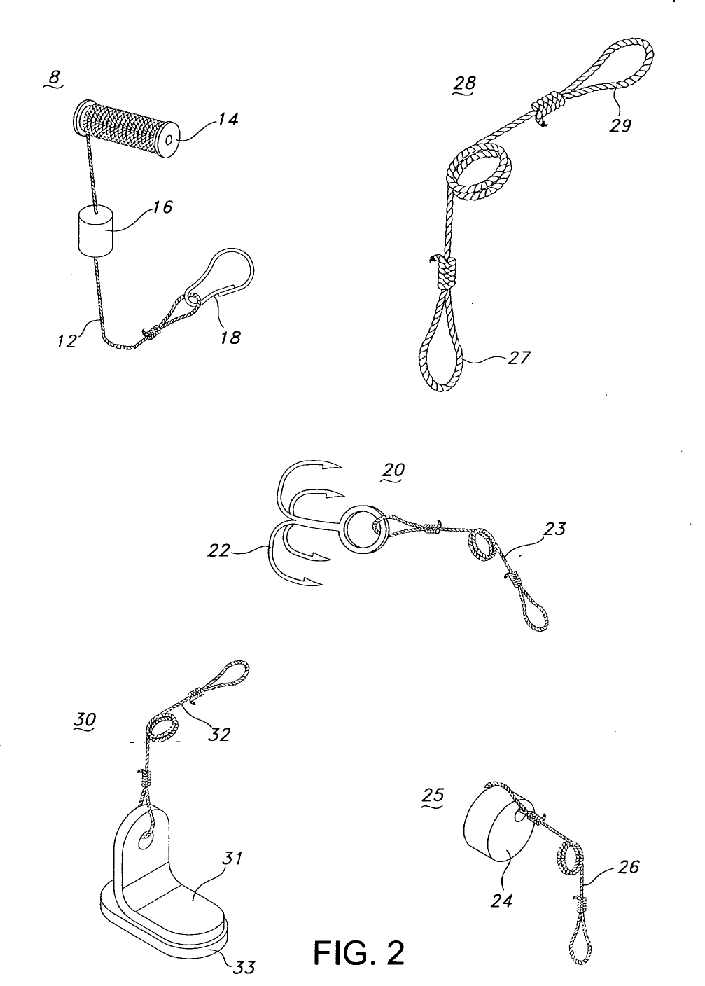

Referring now to the exemplary embodiment shown in FIG. 1, the retrieval kit 10 includes a case 6 comprising separate compartments. According to this exemplary embodiment, the following components are contained in the separate compartments of case 6: master retrieval cable 8, hook component 20, magnet component 24, noose 28, and weighted adhesive component 30. The hook attachment 20, magnet attachment 24, noose attachment 26, and weighted adhesive attachment 30 are referred to herein as ‘retrieval components’ or ‘slave components.’ Exemplary embodiments of each slave component are described in greater detail with respect to FIG. 2.

Referring now to FIG. 2, the slave components of the retrieval kit 10 shown in FIG. 1 are illustrated (case 6 is omitted). The master retrieval cable 8 comprises a cord 12, one end of which is tied, or otherwise attached, to a spool 14, and the other end of cord 12 is tied to a clip 18. The cord 12 is optionally formed from a strong compact nylon line (such as a bow string serving). According to one embodiment, the length of cord 12 is approximately 15 to 30 feet, however other cord lengths are envisioned. The slave components, which are included with the retrieval kit 10, are configured to be releasably mounted to clip 18. The clip 18 may be any common clip or attachment device known in the art. The spool 14 is a conventional thread spool that is provided for neatly winding and unwinding cord 12. In a stored configuration of retrieval cable 8, as shown in FIG. 1, the cord 12 is wound around spool 14. In use, the cord 12 is unwound from spool 14, as shown in FIG. 2. A weight 16, such as a ¼ oz barrel weight, is tied, fastened, or otherwise coupled to a central section of cord 12, to assist with guiding the cord 12 to its target in a windy weather condition.

Referring now to the four slave components shown in FIG. 2, the slave components are configured to be coupled to clip 18 of master retrieval cable 8. Each slave component is adapted to serve a specific retrieval purpose, as described in greater detail with reference to each slave component.

The hook component 20 comprises a hook 22 and an independent cord 23 (such as a nylon bow string serving) that is tied, or otherwise fastened, through a hole provided at the top end of hook 22. The hook 22 is useful when for retrieving a cloth item or any item having a rope attachment, or uneven surfaces. According to one embodiment, hook 22 is a sharp thresher-type hook having a plurality of barbs (e.g., a fish hook). The independent cord 23 is an optional component, as the length of cable 12 may be sufficient. The independent cord 23 includes a loop on the opposite end of cord 23 for connection to clip 18 of master retrieval cable 8. If independent cord 23 is omitted, the clip 18 may be coupled to hook 22 through the hole provided at the top end of hook 22.

The magnet component 25 comprises a compact magnet 24, and an independent cord 26 that is tied, or otherwise fastened, through a hole provided in the body of magnet 24. The magnet is useful for retrieving fallen objects composed of metal, such as a hunting knife. The magnet may be of any shape or size, and according to one exemplary embodiment, the magnet may be able to hold metallic objects having a weight of up to four pounds. The independent cord 26 includes a loop for connection to clip 18 of master retrieval cable 8. The independent cord 26 is an optional component of magnet 25. If independent cord 26 is omitted, the clip 18 may be coupled to magnet 24 through the hole provided in the body of magnet 24.

The weighted adhesive component 30 comprises a metal slug 31, an adhesive tab 33 releasably mounted to the bottom surface of metal slug 31, and an independent cord 32 that is tied, or otherwise fastened, through a hole provided in the body of metal slug 31. The adhesive tab 33 may be a double sided adhesive tape (or glue, spray adhesive). The metal slug 31 is composed of a heavy metal, such as lead, so that the adhesive can be controllably and accurately deployed to retrieve the fallen object below. The metal slug 31 has a smooth lower surface for easy attachment of adhesive tab 33. The independent cord 32 includes a loop for connection to clip 18 of master retrieval cable 8. The independent cord 32 is an optional component of weighted adhesive component 30. If independent cord 32 is omitted, the clip 18 may be coupled to metal slug 31 through the hole provided in the body of metal slug 31.

In use, prior to dropping the weighted adhesive component 30 onto the targeted object (i.e., fallen object) the functional side of the adhesive tab 33 is exposed by peeling-away a release layer. The adhesive component 30 is lowered onto a surface of the targeted object. The exposed side of adhesive tab 33 sticks to the targeted object. Once sufficient contact has been made, master retrieval cable 8 is retracted and the targeted object is retrieved.

The noose 28 is provided to grasp items that are either (1) too heavy for weighted adhesive component 30; (2) do not include any soft material, openings or uneven surfaces desirable for hook component 20; or (3) do not include metallic surfaces desirable for magnet component 25. For example, the noose 28 may be used to retrieve a large cylindrically-shaped plastic thermos, that is too heavy for adhesive component 30, and does not have any openings or uneven surfaces for hook component 20. The noose 28 is optionally constructed of a 1/32 gauge nylon cord, or any other appropriate material. The tensile strength of the nylon cord is equal to or greater than the tensile strength of the retrieval cable 8. End 29 of noose 28 is tied into a “simple noose knot” for grasping the fallen object. The opposite end 27 of noose 28 is looped to allow for connection to the clip 18. It should be understood that noose 28 maybe used without retrievable cable 8, if so desired.

Examples of hunting equipment and accessories capable of being retrieved by one or more slave components 20, 25, 28 and 30 are illustrated below:

| Hunting Item or Accessory | Slave Component(s) |
|---|---|
| Hunting Knife | Magnet/Lasso |
| Pocket Knife | Magnet/Lasso |
| Thermos | Lasso |
| Thermos Cup | Adhesive Weight |
| Release | Hook/Magnet/Lasso |
| Archery Arm Guard | Lasso/Hook |
| Hat | Hook |
| Gloves | Lasso/Hook |
| Scarf | Hook |
| Jacket | Lasso/Hook |
| Neck Warmer | Hook |
| Dear Grunt | Lasso/Hook |
| Doe Bleat in a Can (any size can) | Adhesive |
| Rattling Horns | Hook |
| Binoculars | Hook |
| Arrows | Hook/Magnet |
| Cross Bow Bolts | Hook/Magnet |
| Bullets | Adhesive |
| Bullet Clips for Rifles | Magnet/Hook |
| Eyeglasses/SunGlasses | Magnet/Hook |
| Lunch (Sandwich Bags) | Hook |
| Water Bottle | Lasso |
| Candy Bars | Adhesive/Hook |
| Flashlights | Magnet/Lasso |
| Hand Warmers | Adhesive/Hook |
| Boots | Hook |
| Socks | Hook |
| Safety Belt | Hook |
| Scent Bottles | Lasso/Adhesive |
| Soda Can or Bottle | Lasso/Adhesive |
| Bullets | Adhesive |
| Scope Covers | Hook |
| Hand Warmer Muff | Hook |
| Stand Blinds | Hook |
| Arrow Quiver | Hook/Lasso/Magnet |
| Hot Seat | Hook/Lasso |
| Foam Cushion Seat | Hook/Lasso |
| Global Positioning | Hook/Lasso |
| Walkie Talkie | Lasso/Hook |
| Ear Muffs | Hook |
| Balaclavas | Hook |
| Cell Phone | Hook/Lasso |
| Trash/Paper Wrappers/Tissues | Adhesive |
| Cover Sent Wafers | Adhesive/Hook |
| Cameras | Lasso/Hook |
| Archery Finger Tab | Adhesive/Hook |
| Range Finder | Hook/Lasso |
| Stabilizers | Lasso/Magnet |
| Bow Holder | Lasso |
| Hang On Belt for Accessories | Hook/Lasso |
| Hearing Protection | Adhesive/Lasso/Hook |
| Bow Sling | Hook |
| Bow Hook | Hook/Lasso |
| Bladder Bags | Lasso |
| Camo Make-up (Tubes or Cases) | Adhesive/Lasso |
| Camouflage Face Mask | Hook |
| Wind Tracking Devices | Adhesive/Hook |
| Back Packs | Lasso/Hook |
| Fanny Pack | Lasso/Hook |
| Boot Booties/Foot Warmers | Lasso/Hook/Adhesive |
| Poncho | Hook |
| Portable Roof/Umbrella | Lasso/Hook |
| Electronic Calls | Lasso/Hook |
| Electronic Call Remote Controls | Lasso/Hook |
| Cross Bow Cocking Aid | Lasso/Hook |
| Archers Wrench/Tools | Magnet/Hook |
| Watch | Hook/Adhesive |
| Compass | Hook/Adhesive |
| Cartridge Carrier | Lasso/Hook |
| Rattling Bag | Lasso/Hook |
| Lighters | Magnet/Lasso/Adhesive |
| Wallets | Lasso/Hook |
| Cloth or Plastic Accessory Case | Lasso/Hook |
| First Aid Kit | Lasso/Hook/Adhesive |

In addition, small personal accessories (bandages, aspirin packs, medicine boxes, contact lens case eye drops, etc.) can be retrieved with the adhesive component 30.

Referring back to FIG. 1, retrieval kit 10 comprises a case 6 having separate compartments, whereby the slave components 20, 25, 28 and 30 are neatly organized into the separate compartments of the case. The independent cords of each slave component may be wrapped around the slave component, or, alternatively, the independent cords may be secured to the slave components with a tie or rubber band (not shown). The kit 10 is especially handy for transportation and storage, and is small enough to fit into a pants or jacket pocket, such that the hunter may climb a tree with the retrieval kit in his or her pocket.

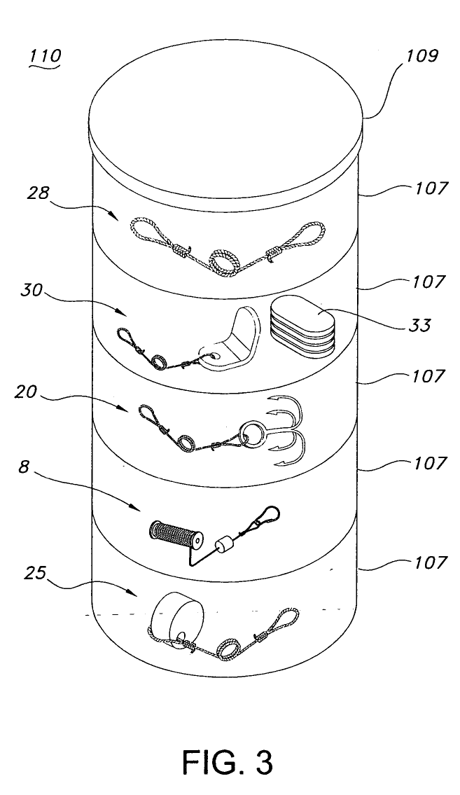

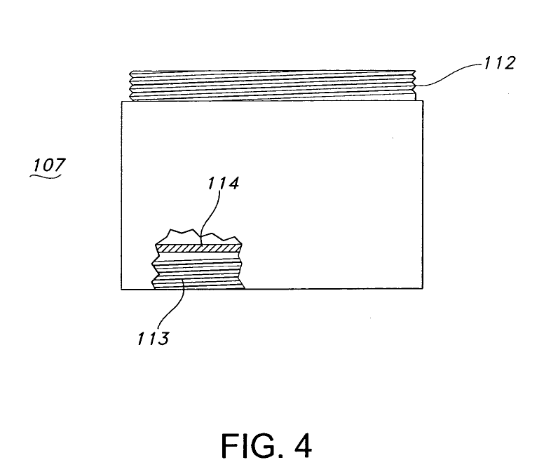

Referring now to FIG. 3, another exemplary embodiment of a equipment and accessory retrieval kit 110 is illustrated. The retrieval kit 110 is similar to kit 10, with the exception of case 106. The case 106 comprises a plurality of stackable compartments 107 (five shown). Each compartment 107 embodies a hollow cylinder, including one open end, and is sized to contain a slave component 20, 25, 28 or 30 or master retrieval cable 8. As shown in FIG. 3, the noose 28 is stored in the ‘top’ compartment, and the magnet component 25 is stored in the ‘bottom’ compartment. A cap 109 is threaded (or snapped) onto the top compartment 107 to enclose the contents therein. The material of each compartment 107 is optionally translucent and/or transparent, such that a user may readily discern the components within each compartment 107. The compartments 107 are threadedly coupled together, as explained in greater detail with reference to FIG. 4.

Referring now to FIG. 4, each compartment 107 is a hollow unitary body including an external threaded region 112 disposed at the top end of compartment 107, and an internal threaded region 113 (shown in the cut-away view of FIG. 4) disposed at the bottom end of compartment 107. The external threaded region 112 is configured to be threadedly engaged with threaded region 113 of a compartment 107 directly thereabove. However, if the compartment 107 is the ‘top’ compartment, cap 109 may be threaded onto the threaded region 112 of compartment 107 to enclose the contents therein, as shown in FIG. 3. Each compartment 107 includes a surface 114 (shown in the cut-away view of FIG. 4), upon which the slave components or master retrieval cable rest. The surface 114 also serves as a cap for the compartment 107 directly therebeneath, with the exception of the ‘bottom’ compartment. Although the compartments are threadedly coupled together, the compartments may also be snap fit or buckled together, or the stackable compartments 107 employ any other releasable connection means known in the art.

As noted, although the present invention is particularly well suited to hunting applications, and in particular portable tree stand hunting applications, the invention is not limited to any specific application or activity. The retrieval kit may be utilized for retrieving any object from an elevated position when the user does not want to move his body to the object. For example, the present invention could also be used by a painter or construction worker on a ladder, roof, scaffolding, or any other elevated platform to retrieve an object, such as a tool or piece of clothing, that has dropped onto the ground. The invention may also be beneficial to boaters and fisherman for retrieving objects that have fallen into the water. Moreover, the retrieval kit is useful for fly-fishermen and other stream fishermen (or any fisherman who wades) because the fly-fishermen carry all of their tackle and equipment on their person, and it is not uncommon for equipment to fall into the water. The present invention allows for the retrieval of fly-fishing related equipment, such as a fly box, a lure, flashlight, sunglasses, etc. Similarly, the present invention can be useful for a hiker who seeks to retrieve a piece of equipment that has fallen down a steep hill or into a river.

While exemplary embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A kit for use by a person in an elevated position above ground level for retrieving an object positioned below the person, said kit comprising:
a cable;
at least two different retrieval components disposed within the kit, wherein each retrieval component may be selectively coupled to the cable and lowered to retrieve the object positioned below the person.

2. The kit of claim 1, further comprising an independent cable that is configured to be coupled between said cable and one of said retrieval components.

3. The kit of claim 1, wherein one of said retrieval components is a hook that is configured to be coupled to said cable.

4. The kit of claim 1, wherein one of said retrieval components is a magnet that is configured to be coupled to said cable.

5. The kit of claim 1, wherein one of said retrieval components is an adhesive component that is configured to be coupled to said cable.

6. The kit of claim 5, wherein said adhesive component is mounted to a weight.

7. The kit of claim 1, further comprising a weight attached to said cable.

8. The kit of claim 1, further comprising a spool, wherein said cable is wound around said spool.

9. The kit of claim 1, wherein one of said retrieval components is a noose that is configured to be coupled to said cable.

10. The kit of claim 1, said kit further comprising a case having multiple compartments for storing said retrieval components and said cable.

11. The kit of claim 10, wherein said case comprises separate stackable compartments.

12. The kit of claim 11, wherein each stackable compartment is configured to be threadedly coupled to an adjacent stackable compartment.

13. The kit of claim 12, wherein each stackable compartment includes an exterior threaded region for coupling to an adjacent stackable compartment and an interior threaded region for coupling to another adjacent stackable compartment.

14. The kit of claim 11, wherein each compartment is configured to be snap-fit to an adjacent compartment.

15. The kit of claim 1, further comprising at least four different retrieval components disposed within the kit, wherein said retrieval components are a hook, magnet, adhesive component, and a noose.

16. A kit for use by a person in an elevated position above ground level for retrieving an object positioned below the person, said kit comprising:
a cable;
at least four different retrieval components disposed within the kit, wherein each retrieval component may be selectively coupled to the cable and lowered to retrieve the object positioned below the person; and
at least three intermediate cables, wherein each intermediate cable is configured for attachment between said cable and one of said at least four retrieval components.

17. The kit of claim 16, wherein said at least four different retrieval components are a hook, magnet, adhesive component, and a noose.

18. A kit for use by a person in an elevated position above ground level for retrieving an object positioned below the person, said kit consisting of a cable, a hook, a magnet, an adhesive component, and a noose, wherein each retrieval component may be selectively coupled to an end of the cable and lowered to retrieve the object positioned below the person.
